(19) United States
(12) Patent Application Publication
(10) Pub. No.: US 2010/0289826 A1
(43) Pub. Date: Nov. 18, 2010

(54) METHOD AND APPARATUS FOR DISPLAY SPEED IMPROVEMENT OF IMAGE

(75) Inventors: Jung Hoon Park, Gyeongsangbuk-do (KR); Young Sik Park, Daegu Metropolitan City (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/748,571

(22) Filed: Mar. 29, 2010

(30) Foreign Application Priority Data
May 12, 2009 (KR) 10-2009-0041391

(51) Int. Cl. G09G 5/00

(52) U.S. Cl. 345/676

(57) ABSTRACT

Provided is a method of improving an output speed of an image being generated on a display includes generating a drag event of the image; checking a coordinate in a preset cycle in case the drag event is generated; predicting a next coordinate to which the image is to be moved by comparing a current coordinate with a previous coordinate of the preset cycle; and rendering the image to the predicted next coordinate.

### CLAIM OF PRIORITY

This application claims the benefit of an earlier Korean patent application filed in the Korean Intellectual Property Office on May 12, 2009 and assigned Serial No. 10-2009-0041391, and the entire disclosure of which is hereby incorporated by reference

### BACKGROUND OF THE INVENTION

1. Field of the Invention

The present invention relates to a method and apparatus capable of improving an output speed of image projection, and more particularly, to a method and apparatus capable of improving an output speed of image generation through a coordinate prediction scheme.

2. Description of the Related Art

A portable terminal provides various functions, such as the MP3 function, the mobile broadcasting reception function, the video play function, and the camera function. Recent portable terminals are smaller and slimmer, and provide more convenient user interface (UI) via touch screen.

A touch screen serves as an interface between a communication information equipment using various displays through an input instrument such as finger or touch pen. The touch screen is widely used in various instruments including Automated Teller Machine (ATM), Personal Digital Assistant (PDA), and Notebook computer and various fields including the bank, the government office, and the traffic guidance center or the like. Such touch screen has various types such as the piezoelectric type, the capacitive type, the ultrasonic wave type, the infrared type, and the surface acoustic wave type.

In operation, the portable terminal can output a specific image (e.g., icon) in the touch screen and provides a rendering process so as to output the image. According to the performance of micro-processor which the portable terminal uses, time it requires to project the image varies. That is, the projection of image output can be delayed as much as a given time (hereinafter, rendering time) required for rendering. Particularly, in case of dragging (moving) the image, portable terminal must continuously perform rendering and outputting of the image. However, in case of dragging image mode, there is a problem in that the output generation of image is delayed due to the rendering time which in turn causes that the image display to be momentarily paused.

### SUMMARY OF THE INVENTION

The present invention has been made in view of the above problems, and provides a method and apparatus capable of improving an output speed of image being displayed through a coordinate prediction, which can smoothly move and output image without momentarily pausing the display of image. This is achieved by predicting a coordinate to which image is to be moved when the image is dragged while processing/rendering is still being performed.

In accordance with an aspect of the present invention, a method of improving an output speed of an image being generated on a display includes generating a drag event of the image; checking a coordinate in a preset cycle in case the drag event is generated; predicting a next coordinate to which the image is to be moved by comparing a current coordinate with a previous coordinate of preset the cycle; and rendering the image to the predicted next coordinate.

In accordance with another aspect of the present invention, a method of improving an output speed of image includes generating a movement event of the image; predicting a movement path of the image according to the movement event; and rendering the image according to the predicted movement path.

In accordance with another aspect of the present invention, a apparatus of improving an output speed of an image being generated on a display includes a coordinate prediction unit that predicts a next coordinate, by comparing a current coordinate with a previous coordinate when a drag event of the image is generated; a rendering performing unit which renders the image to the predicted next coordinate; and a controller which controls an output of the rendered image.

### BRIEF DESCRIPTION OF THE DRAWINGS

The above and other aspects, features, and advantages of certain exemplary embodiments of the present invention will be more apparent to those skilled in the art from the following description taken in conjunction with the accompanying drawings, in which:

FIG. 1 is a block diagram illustrating a portable terminal according to an exemplary embodiment of the present invention;

FIG. 2 is a drawing illustrating a coordinate prediction method according to an exemplary embodiment of the present invention;

FIG. 3 is a flowchart illustrating a process of improving an output speed of image through coordinate prediction according to an exemplary embodiment of the present invention; and

FIG. 4 is a screen illustrating an image output through coordinate prediction according to an exemplary embodiment of the present invention.

### DETAILED DESCRIPTION OF THE INVENTION

Exemplary embodiments of the present invention are described with reference to the accompanying drawings in detail. The same reference numbers are used throughout the drawings to refer to the same or like parts. For the purposes of clarity and simplicity, detailed descriptions of well-known functions and structures incorporated herein may be omitted to avoid obscuring the subject matter of the present invention.

The meaning of terms is clarified in this disclosure, so the claims should be read with careful attention to these clarifications. Specific examples are given, but those of skill in the relevant art will understand that other examples may also fall within the meaning of the terms used, and within the scope of one or more claims. Terms do not necessarily have the same meaning here that they have in general usage, in the usage of a particular industry, or in a particular dictionary or set of dictionaries. In the event of an irresolvable conflict between a term's meaning as used expressly herein and the term's meaning as used in an incorporated document, the express meaning herein governs. Although this disclosure and the associated drawings fully detail several alternate exemplary embodiments of the present invention, further alternate embodiments can be implemented without departing from the scope of this invention. Consequently, it is to be understood that the following disclosure is provided for exemplary purposes only and is not intended as a limitation of the present invention. Furthermore, all alternate embodiments which are obvious modifications of this disclosure are intended to be encompassed within the scope of the present invention

Hereinafter, before the detailed description of the present invention, for the sake of convenience in illustration, a portable terminal according to an exemplary embodiment of the present invention is a terminal including touch screen, can be applied to all other information communication instruments and multimedia devices and applications thereof, such as navigation terminal, electronic dictionary, digital broadcasting terminal, Personal Digital Assistant (PDA), Smart Phone, International Mobile Telecommunication 2000 (IMT-2000) terminal, Code Division Multiple Access (CDMA) terminal, Wideband Code Division Multiple Access (WCDMA) terminal, Global System for Mobile communication (GSM) terminal, and Universal Mobile Telecommunication Service (UMTS) terminal.

Hereinafter, “touch” refers to a state where user contacts an input instrument such as finger or touch pen to the touch screen surface.

Hereinafter, “drag” refers to a behavior of moving an input instrument such as finger or touch pen in the state where the touch is maintained.

Hereinafter, “touch release” refers to a behavior of separating finger or touch pen contacted with touch screen from touch screen.

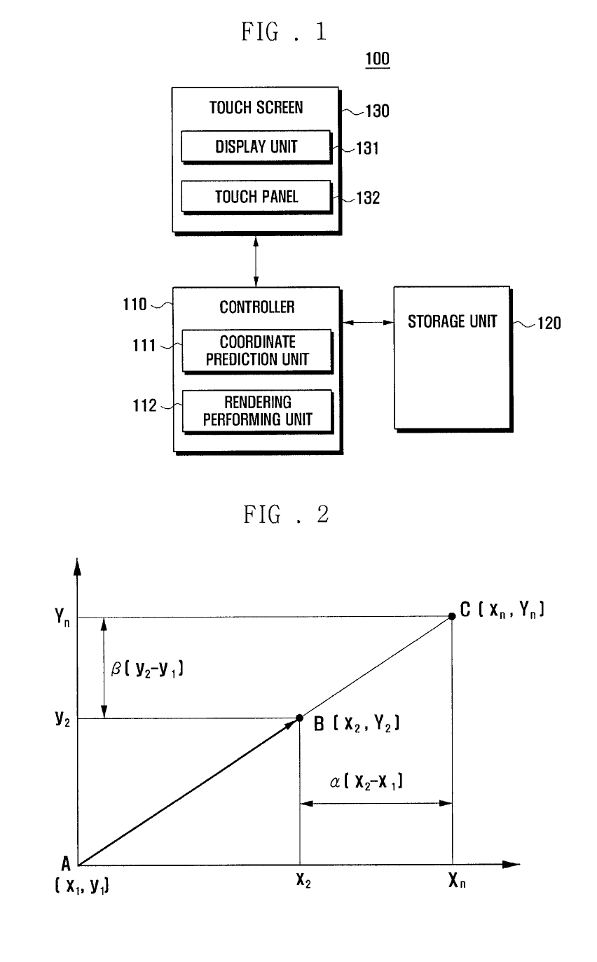

FIG. 1 is a block diagram illustrating a portable terminal according to the embodiment of the present invention, FIG. 2 is a drawing illustrating a coordinate prediction method according to an exemplary embodiment of the present invention.

Referring to FIG. 1, a portable terminal 100 according to an exemplary embodiment of the present invention includes a controller 110, a storage unit 120 and a touch screen 130.

The storage unit 120 can store a program necessary to perform the overall operation of the portable terminal 100 and to perform communication with mobile communication network, and can store data generated in the execution of the program. That is, the storage unit 120 can store Operating System (OS) which boots the portable terminal 100, an application program necessary for operating the function of the portable terminal 100, and data generated according to the use of the portable terminal 100. Particularly, the storage unit 120 can store a program for coordinate prediction, and a rendering program of image. Moreover, the storage unit 120 can store the maximum value of the horizontal component increment and the vertical component increment which are described later. The storage unit 120 can be configured of Read Only Memory (ROM), Random Access Memory (RAM), and Flash memory.

The touch screen 130 can include a display unit 131 for outputting screen data, and a touch panel 132 which is coupled to the front side of the display unit 131.

The display unit 131 can output screen data generated when performing the function of the portable terminal 100, and state information according to the key operation and function setting of user. Moreover, the display unit 131 can visually display various signals and color information outputted from the controller 110. For example, in case an image displayed in one side of the display unit 131 is dragged, the display unit 131 moves the image under the control of the controller 110 and can output it. Particularly, the display unit 131 predicts next coordinate when image is dragged and performs rendering under the control of the controller 110. Thus, the image can be rapidly outputted without time delay due to a predetermined time (hereinafter, rendering time) required for rendering. Such a display unit 131 can be configured of Liquid Crystal Display (LCD) and Organic Light-Emitting Diode (OLED) or the like.

The touch panel 132 which is mounted on the front side so as to be laid over the display unit 131, and senses a touch, a drag, and a touch release event to transmit to the controller 110. The touch panel 132 may include a piezoelectric type, a capacitive type, an infrared type, and an optical sensor and electromagnetic induction type. If touch is generated, the physical characteristic of touched spot is changed and, then, the touch panel 132 transmits a signal indicative of such a change to the controller 110, so that touch, drag, and touch release event can be recognized. For instance, in the touch panel of the capacitive type, if touch is generated, the electrostatic capacity of the touched spot is increased. In case such a change (the increase of electrostatic capacity) is equal to a preset threshold or greater, it can be recognized that touch event is generated. As the driving method of such touch panel 132 well known to a person skilled in the art of the present invention, the detailed description is omitted to avoid redundancy.

The controller 110 performs the overall control for the portable terminal 100, and can control a signal flow between internal blocks of the portable terminal 100 shown in FIG. 1. That is, the controller 110 can control a signal flow between respective configurations such as the touch screen 130 and the storage unit 120. The controller 110 can recognize touch, drag, and touch release event through a signal sent from the touch panel 132. In more detail, the controller 110 senses the generation of touch event through the change of signal according to the change of the physical characteristic, which is generated when user touches a specific portion of the touch panel 132 via an input instrument such as finger or touch pen, and can calculate coordinate in which the touch event is generated. Then, the controller 110 can determine that touch is released when the change of signal does not occur. Moreover, when coordinate is changed without the touch release event after the generation of touch event, the controller 110 can determine that drag event is generated. Moreover, the controller 110 can control to render image and output it to the display unit 131. Particularly, in case user drags the image (icon) outputted to the display unit 131, the controller 110 predicts next coordinate by using a current coordinate and a previous coordinate, and can perform the rendering of image in the predicted next coordinate. That is, the controller 110 can predict the movement route of icon, and can perform the rendering for the image output according to the predicted movement route. To this end, the controller 110 can include a coordinate prediction unit 111 and a rendering performing unit 112.

The coordinate prediction unit 111 can predict next coordinates by using current coordinates and previous coordinates when a drag event is generated. To this end, the coordinate prediction unit 111 checks coordinate in a preset cycle, set the most recent coordinate as a current coordinate, and set the coordinate which is checked at immediately before cycle as a previous coordinate.

Hereinafter, the coordinate prediction method is illustrated in detail with reference to FIG. 2. In case drag is generated from A spot to B spot, the coordinate prediction unit 111 can calculate the horizontal component increment and the vertical component increment with B (X2, Y2) spot as a current coordinate, and A (X1, Y1) spot as a previous coordinate. At this time, the horizontal component (X-axis direction) increment is “X2−X1”, and the vertical component (Y-axis direction) increment is “Y2−Y1”. The coordinate prediction unit 111 can predict next coordinate C (Xn, Yn) by using the horizontal component increment and the vertical component increment. That is, the coordinate prediction unit 111 can predict next coordinate C (Xn, Yn) by adding the horizontal component increment and the vertical component increment to the current coordinate. It can be expressed like Equation 1.

Xₙ=X₂+(X₂−X₁), Yₙ=Y₂+(Y₂−Y₁) [Equation 1]

Here, Xₙ refers to the horizontal component of next coordinate, and Yₙ refers to the vertical component of next coordinate. In another embodiment of the present invention, respective weight values can be multiplied to the horizontal component increment and the vertical component increment. That is, Equation 1 can be changed like Equation 2.

Xₙ=X₂+α(X₂−X₁), Yₙ=Y₂+β(Y₂−Y₁) [Equation 2]

Here, the weight value α and β are a real number which is greater than 0, a and β can be the same or can be different. The weight value α and β can be determined by experiments that yield an optimal outcome by designers. At this time, designer can set the maximum value (e.g., 20) of the horizontal component increment and the vertical component increment to which the weight value α and β are multiplied. In this case, unnatural movement which can be generated when user changes direction without dragging to the predicted coordinate can be minimized. Moreover, the phenomenon of moment migration of image which is caused by far distance to the predicted coordinate can be prevented. In the meantime, the maximum value of the horizontal component increment and the maximum value of the vertical component increment can be set with a different value.

The rendering performing unit 112 is an apparatus for rendering the image outputted to the display unit 131. Rendering is a process of designing realistic images in consideration of shadow, color and shade which are differently displayed according to the form of image, location and illumination. That is, rendering means a process of adding realism by changing the shadow or shade of a two-dimension object for cubic effect. Particularly, the rendering performing unit 112 can perform rendering a head of time so as to output image to coordinate predicted by the coordinate prediction unit 111. Thereafter, when the controller 110 senses that image is moved to the predicted coordinate, it can control to output the rendered image to the predicted coordinate.

In the meantime, in the above, it is illustrated that the increment is determined by checking a difference of the horizontal component and vertical component between the current coordinate and the previous coordinate, but the present invention is not limited to this. For example, the increment of the horizontal component and vertical component can be set with a specific value.

Moreover, although not illustrated, the portable terminal 100 can selectively further include elements having the supplementary feature such as a camera module for image or video photographing, a local communications module for the local wireless communication, a broadcasting reception module for the broadcasting reception, a digital music playing module like a MP3 module, and an internet communication module which communicates with internet network and performs internet function. A variant of such element is so various due to the trend of the convergence of digital device that it cannot be enumerated. However, the portable terminal 100 can further include elements which are equivalent to the above mentioned elements.

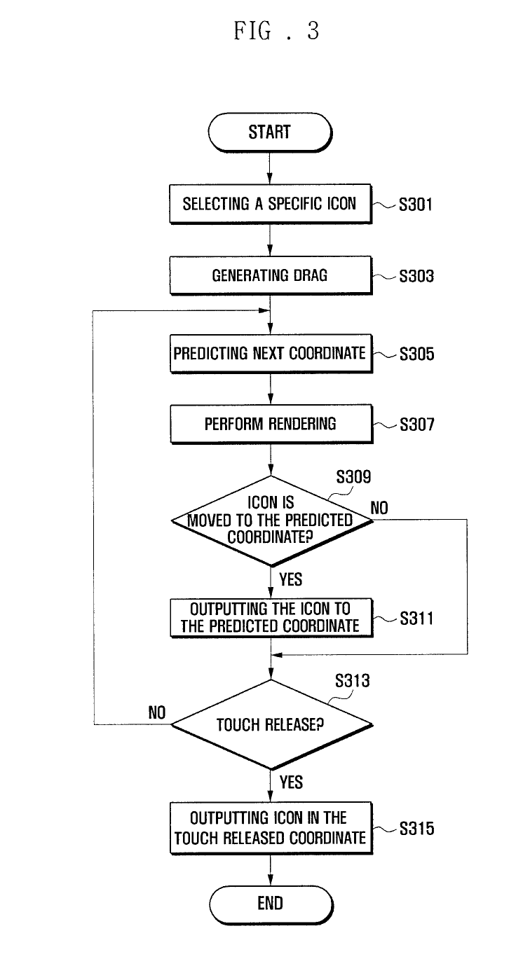

FIG. 3 is a flowchart illustrating a process of improving an output speed of image using a coordinate prediction scheme according to an exemplary embodiment of the present invention.

Hereinafter, for the sake of convenience of illustration, the case of moving icon is illustrated. However, the present invention is not limited to this. That is, the present invention can be applicable to the case where at least part of the image outputted to the display unit 131 is moved according to drag event while other area of image which was not outputted to the display unit 131 is outputted.

Referring to FIGS. 1 to 3, the controller 110 can sense that user selects (touches) a specific icon (S301). Then, the controller 110 can sense the generation of drag event of the specific icon (S303). When the generation of drag is sensed, the coordinate prediction unit 111 of the controller 110 can predict next coordinates by using a difference of the horizontal component and vertical component between the current coordinates and the previous coordinates (S305). To avoid redundancy, the detailed description of the coordinate prediction method is omitted as it was illustrated in the above with reference to FIG. 2.

The rendering performing unit 112 of the controller 110 can perform rendering so that the specific icon may be outputted to the predicted next coordinate (S307). Then, the controller 110 can check whether the icon is moved to the predicted coordinate (S309). This can be checked through sensing a signal which is generated due to drag by finger or touch pen in the predicted next coordinate.

In case icon moves to a predicted spot at step S309, the controller 110 can output the icon to the predicted spot (S311). At this time, the display unit 131 can output the icon without momentarily pausing of displaying icon caused by rendering time through the prediction coordinate method described above. On the other hand, in case icon does not move to the predicted spot at step S309, the controller 110 can proceed to step 313.

The controller 110 can check whether a touch release signal is generated (S313). When the touch release signal is not generated at step S313, the controller 110 returns to step S305 and can repeat the above described process. On the other hand, when the touch release signal is generated at step S313, the controller 110 can render the icon in the coordinate in which touch release occurs and output the rendered icon (S315). At this time, the controller 110 can remove the icon rendered in the next coordinate.

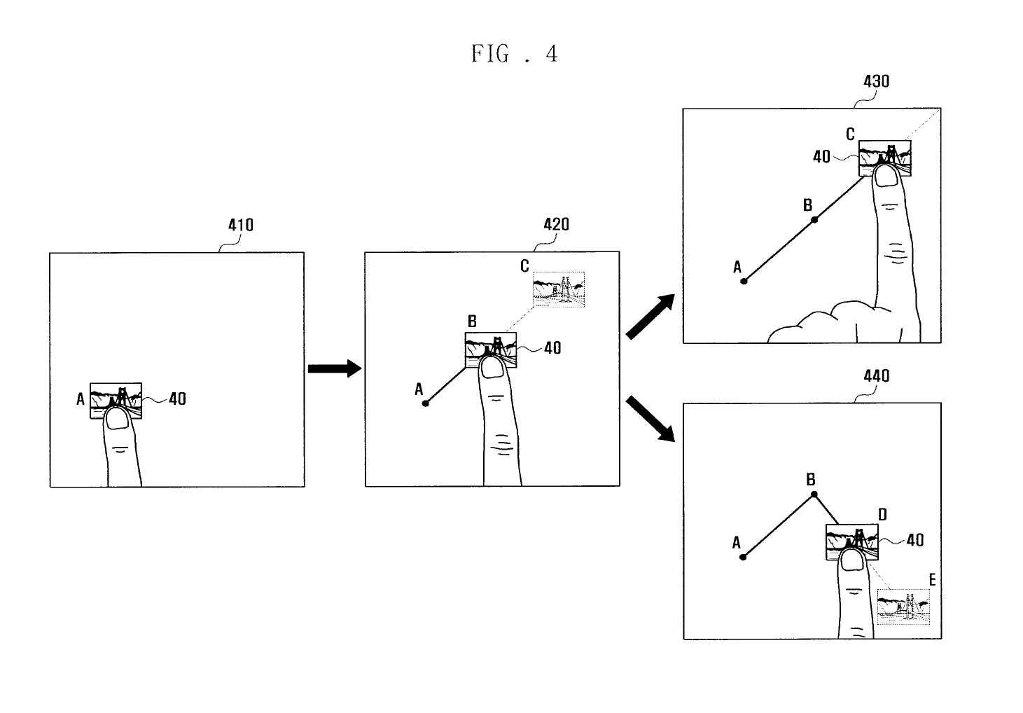

FIG. 4 is a screen illustrating an image output through coordinate prediction according to an exemplary embodiment of the present invention.

Referring to FIGS. 1 and 4, as shown in a first screen 410, a user can touch an icon 40 outputted to A spot of the display unit 131 by finger. Then, as shown in a second screen 420, the user can drag the icon 40 to B spot. At this time, the coordinate prediction unit 111 of the controller 110 can predict the coordinate of C spot by using the coordinate of A spot and the coordinate of B spot. The coordinate of C spot can be predicted by using the increment of the horizontal component and vertical component of the coordinate of A spot and the coordinate of B spot, as described with reference to FIG. 2. Then, the rendering performing unit 112 of the controller 110 can perform rendering so as to output the icon 40 in the predicted C spot without a pause or interruption of displaying the icon continuously during the drag movement.

As shown in a third screen 430, when user drags the icon 40 to C spot, the controller 110 can output the icon 40 to C spot of the display unit 131. At this time, since rendering is performed by the controller 110 to the C spot, the display unit 131 can immediately output the icon 40 to the C spot without the delay of rendering time. That is, the controller 110 performs rendering through coordinate prediction a head of time or simultaneously, so that it can output the icon 40 to C spot continuously without a delay or interruption associated with time delay due to the performance of typical rendering.

In the meantime, in case a user does not drag the icon 40 to the predicted C spot, but changes the direction, as shown in a fourth screen 440, to drag the icon 40 to D spot, the controller 110 can output the icon 40 to D spot by performing a typical rendering process. At this time, the controller 110 can remove the icon rendered in the C spot. And the coordinate prediction unit 111 can predict the coordinate of E spot for next movement by using the coordinates of C spot and D spot. Thus, the rendering performing unit 112 of the controller 110 can perform rendering so as to output the icon 40 in the predicted E spot.

As described above, the present invention performs the rendering of image in the predicted coordinate a head of time, so that the icon output generation due to the rendering time is not delayed. Accordingly, image display is not momentarily paused when icon is dragged. Note that in a portable terminal in which the rendering speed of image is slow due to the limit of the image process performance, the improvement of image processing speed can be more felt.

Note that a solid line and a dotted line shown in FIG. 4 are shown so as to indicate the movement direction of the icon 40, but not actually be outputted to the display unit 131. Moreover, in FIG. 4, the solid line represents a practical movement path of the icon 40, the dotted line represents a prediction movement path of the icon 40.

In the meantime, the case of dragging the icon 40 was exemplified in the above, but the present invention is not limited to this. That is, the present invention can be applicable to other cases where image outputted to the display unit 131 according to drag event is moved and the moved image is outputted. For example, in case the user image is moved to a specific direction so as to check a portion which is not outputted to display unit in the state where an image having a large size (e.g., map) is outputted, the present invention can predict a movement path (movement direction and distance) of the image, and renders a next output image in response to the movement path so that image can be outputted without rendering time delay.

As described above, according to a method and apparatus capable of improving an output speed of image through coordinate prediction suggested in the present invention, the output of icon due to the rendering time is not delayed by performing the rendering process a head of time for outputting image through the movement path prediction of image, so that display of image is not paused momentarily and image can be smoothly outputted.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method of improving an output speed of an image being generated on a display, the method comprising:
generating a drag event of the image;
checking a coordinate in a preset cycle in case the drag event is generated;
predicting a next coordinate to which the image is to be moved by comparing a current coordinate with a previous coordinate of the preset cycle; and
rendering the image to the predicted next coordinate.

2. The method of claim 1, further comprising:
outputting the rendered image to the next coordinate in case the image is dragged to the next coordinate.

3. The method of claim 1, further comprising:
removing the rendered image in the next coordinate in case the image is touch-released or a drag direction of the image is changed before the image is dragged to the next coordinate.

4. The method of claim 3, further comprising:
rendering the image and outputting the rendered image to a spot where touch is released.

5. The method of claim 1, wherein predicting the next coordinate comprises:
calculating a horizontal component increment between the previous coordinate and the current coordinate;
calculating a vertical component increment between the previous coordinate and the current coordinate; and
adding the horizontal component increment to a horizontal component of the current coordinate, and adding the vertical component increment to a vertical component of the current coordinate.

6. The method of claim 5, further comprising:
multiplying the horizontal component increment and the vertical component increment by a predetermined weight value.

7. The method of claim 5, wherein the horizontal component increment and the vertical component increment are set to a size which is equal to or less than a preset maximum value.

8. An apparatus of improving an output speed of an image being generated on a display, comprising:
a coordinate prediction unit which predicts a next coordinate by comparing a current coordinate with a previous coordinate when a drag event of the image is generated;
a rendering performing unit which renders the image to the predicted next coordinate; and
a controller which controls an output of the rendered image.

9. The apparatus of claim 8, wherein the controller controls to output the rendered image to the predicted next coordinate in case the image is dragged to the next coordinate.

10. The apparatus of claim 8, wherein the controller controls to remove the rendered image in case the image is not dragged to the predicted next coordinate when a touch-release event is generated, and to output the rendered image to a spot where the touch-release event is generated.

11. The apparatus of claim 8, wherein the controller removes the rendered image in case the image is not dragged to the predicted next coordinate and a drag direction is changed.

12. The apparatus of claim 8, wherein the coordinate prediction unit calculates a horizontal component increment and a vertical component increment respectively by comparing the current coordinate with the previous coordinate, and predicts the next coordinate by adding the horizontal component increment to a horizontal component of the current coordinate and adding the vertical component increment to a vertical component of the current coordinate.

13. The apparatus of claim 8, wherein the coordinate prediction unit predicts the next coordinate by multiplying the horizontal component increment and the vertical component increment by a preset weight value.

14. The apparatus of claim 12, further comprising a storage unit which stores a maximum value of the horizontal component increment and the vertical component increment.

15. A method of improving an output speed of an image being generated on a display, the method comprising:
generating a movement event of the image;
predicting a movement path of the image according to the movement event; and
rendering the image according to the predicted movement path.

16. The method of claim 15, wherein predicting the movement path of the image comprises:
checking a coordinate in a preset cycle; and
calculating a movement direction and a distance by comparing a current coordinate with a previous coordinate.

17. The method of claim 16, wherein calculating the movement direction and the distance comprises:
calculating a horizontal component increment between the previous coordinate and the current coordinate;
calculating a vertical component increment between the previous coordinate and the current coordinate; and
adding the horizontal component increment to a horizontal component of the current coordinate, and adding the vertical component increment to a vertical component of the current coordinate.

18. The method of claim 17, further comprising multiplying the horizontal component increment and the vertical component increment by a predetermined weight value.

19. The method of claim 15, further comprising outputting the rendered image in case the image is moved to the predicted movement path.

20. The method of claim 15, further comprising removing the rendered image in case the image is not moved to the predicted movement path.
